(19) United States
(12) Patent Application Publication
(10) Pub. No.: US 2013/0008318 A1
(43) Pub. Date: Jan. 10, 2013

(54) REDUCING DOOR TEMPERATURES BY TINTED GLASS, ALUMINUM PAINT ON GLASS, AND INSULATION SCREENING ON GLASS

(75) Inventor: Jaime Alexander McPherson, Signal Mountain, TN (US)

(73) Assignee: General Electric Company

(21) Appl. No.: 13/178,020

(22) Filed: Jul. 7, 2011

(51) Int. Cl. A47J 37/04; B05D 3/10

(52) U.S. Cl. 99/341; 427/299

(57) ABSTRACT

Reductions in door temperature can be achieved through use of tinted glass, insulation paint, and/or reflective or conductive surfaces on the glass. The oven glass can be doped or tinted so that the degree of tint alters the radiation or heat transfer. Aluminum can be used as a heat sink and a reflective layer in order to serve as a gradient and direct heat to a low temperature region while eliminating assembly costs. Insulating paint can likewise be screened or located at specific, desired regions.

### BACKGROUND OF THE DISCLOSURE

This disclosure relates to reducing oven door temperatures by reducing radiation transmission. Selected aspects may find application in other cooking devices where similar issues may arise.

Oven assemblies oftentimes use glass to allow a user to view the oven chamber during cooking, that is, without having to open the oven door. One design style places the exterior glass along the outside surface of the oven door, that is, where the entire outer surface is formed of glass. In other designs, the window is part of an assembly that is bordered about its perimeter by a door frame. It is generally advantageous to keep the surfaces facing and within the oven as close to the operating oven temperature as possible to promote a minimal heat loss, while ensuring good pyrolitic cleaning performance during self-clean oven operations. Alternatively, it is generally advantageous to keep door components outside of the inside surface as cool as possible to reduce costs, air flow requirements, and meet regulatory requirements in areas exposed to human and household cabinet contact with door closed.

Appliance manufacturers have traditionally used clear glass with a tin oxide coating in an effort to reduce radiation transmission. It is also known to apply aluminum-backed tape to a rear side of an outer door glass to reflect radiation or act as a heat sink. Still another region where reduced radiation transmission has been traditionally addressed is by applying insulation with a taped back to a rear surface of an outer door glass to insulate the door. In some cases, manufacturers will apply additional non-structural glass and metal components to further retard heat transfer through the door.

However, a need exists for alternative solutions to further reduce radiation transmission in order to retain heat within oven cavity and decrease temperatures within the door structure and at external surfaces of the door structure which can lead to reducing total door cost or reducing an engineering cost to design the door, and simpler designs that eliminate manually intensive assembly or components.

### SUMMARY OF THE DISCLOSURE

An assembly for reducing door temperatures in a cooking apparatus includes a cooking appliance having a cooking cavity with a door hingedly secured to the appliance allowing selective access to the cooking cavity in an open position, and limiting access to the cooking cavity in a closed position. A window forms at least a portion of the door assembly and a door temperature reducing component includes at least one of an insulating paint on metal components of the door, tinting in the window, and heat transfer through select portions of the window and insulating material, preferably a reflective thermal barrier coating applied in the non-visible surfaces of the door components.

The insulating paint is applied to at least portions of metal components or surfaces facing the oven cavity in a door closed position to reduce heat transfer therethrough or redirect heat transfer.

Window tinting includes a doping material added to a glass that forms the window to reduce heat transfer therethrough.

The window tinting is provided throughout an entirety of the window in a preferred arrangement.

A heat transfer coating can be either a reflective coating or a conductive coating, and in one preferred arrangement is an aluminum coating on an outer door glass while in another preferred arrangement the aluminum coating is applied to an interior surface of the outer door glass, preferably applied to the non-visible surfaces of the door components.

The aluminum coating preferably extends over only a portion of the outer door glass, desirably extending over a perimeter portion of the outer door glass.

A method of reducing thermal transfer through a door of a cooking appliance includes providing a housing having a cooking cavity, providing a door that allows selective access to the cooking cavity, and reducing heat radiation through the door by at least one of coating at least a portion of a surface of the window with a heat transfer material that directs heat from the cooking cavity toward a low temperature region, applying an insulated paint on at least a portion of the metal component of the door, or incorporating a tint into the window.

The method further includes applying aluminum to a surface of the window, preferably applying aluminum to a perimeter portion of the window.

A primary benefit of the present disclosure is the reduction in radiation through the oven door.

Another benefit resides in the increased oven efficiency.

Yet another advantage is associated with the decreased internal oven door temperatures that can either reduce total door cost, or reduce the engineering cost required to design the oven door.

Still another advantage is associated with a reduced number of components or parts required for the oven doors.

A further advantage resides in the reduced labor and associated cost advantage resulting from reduced labor.

Still other benefits and advantages will become apparent from reading and understanding the following detailed description.

### BRIEF DESCRIPTION OF THE DRAWINGS

FIG. 1 is an exploded perspective view of an inner door assembly.

FIG. 2 is an exploded perspective view of an outer door glass assembly.

FIG. 3 is an exploded perspective view of an outer door glass assembly in a stainless steel model of oven door.

### DETAILED DESCRIPTION

There are various styles of ovens, and likewise oven door assemblies. In some, exterior glass forms the outside surface of the oven door, that is, the entire outer surface of the oven door is formed of a glass material. In other oven door assemblies, the glass or window is part of an inner assembly (or window pack assembly) and selected portions of the present disclosure are concerned with the perimeter area assembly around the viewing window.

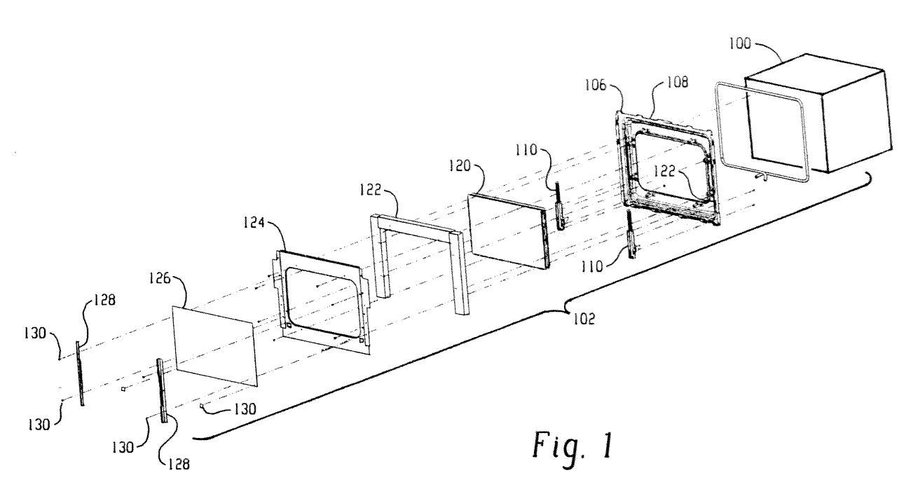

Turning first to FIG. 1, there is shown a cooking appliance or oven 100 to which is hingedly secured an inner door assembly 102. The oven 100 is of conventional construction and is well understood by one skilled in the art so that further discussion herein is deemed unnecessary to a full and complete understanding of the present disclosure. The inner door assembly 102 includes a gasket 104 received around a perimeter portion of frame 106, and more particularly the gasket is secured to a first surface 108 of the frame. Hinges 110, preferably one provided on each side of the oven door, interconnect the oven door assembly 102 to the oven 100. A window pack 120 is received on the second surface 122 of the frame 106. Surrounding perimeter portions of the window pack are one or more insulation components 122 and the outer or front surface of the window pack and insulation are typically enclosed by an insulation retainer panel 124. As is known in the art, the frame 106 and insulation retainer panel 124 are typically metal components and will be discussed further below with regard to the door temperature reduction features of the present disclosure. Located outwardly of the insulation retainer panel in some constructions is a glass oven door 126, which is retained by brackets 128 and associated fasteners 130.

One manner of reducing the oven door temperature is to coat or paint the insulation retainer panel 124, heat shields (not shown), or still other metal components of the oven door assembly with a paint (also referred to herein as an insulation paint) in order to reduce or redirect heat transfer. An insulating material is added to the paint. Preferred insulating materials incorporated into the paint may include air, glass or ceramic insulators such as at least one of ceramic fiber, ceramic beads, glass fiber, or aerogel, or combinations of one or more of these insulating materials in order to enhance the thermal barrier. In addition, the insulating paint can be selectively screened on a back side of the outer door glass to reduce conductive heat transfer to the outer door glass. As noted above, the insulating paint can be applied to the insulation retainer panel to prevent the internal oven door air from getting hot. The glass oven door 126 can be locally screened, painted with aluminum paint, tinted, or locally painted with insulating paint to prevent infrared (IR) transmission. This screening, painting, or tinting is especially useful in non-visible areas of the glass oven door or window pack. The insulating paint can be applied to at least portions of a retainer, decorative trim, shield, interior or exterior panel of the oven door assembly.

In addition, the inner surface of the glass oven door 126, or inner surface of the window pack 120, can be tinted or screened with a reflective, doped, or conductive heat transfer coating such as an ink to prevent infrared transmission, or with an ink that contains an infrared or IR reducing material that limits transmission of specific wavelengths. The tinted or ink-screened door glass is intended to prevent transmission of thermals or IR wavelengths. It is also contemplated that this tinting could possibly be used in conjunction with a tin oxide coating which is traditionally used by appliance manufacturers on clear glass to reduce radiation transmission. As will be appreciated by one skilled in the art, doping the glass or altering the degree of tint, in turn, alters the radiation or heat transfer properties of the surface.

Still another possibility is to apply silver, zinc, or aluminum, for example, along selected metal surfaces, although if these materials are used, oxidation would have to be addressed in order to improve the efficiency. Typically, these materials are applied in a vacuum deposition process. Typically IR reflectivity is achieved by the use of white pigments using such materials as tin oxide, titanium oxide, metallic (silver, zinc, gold) flakes, cadmium stannate (Cd2 SnO4), aluminum oxide, thorium oxide, and zirconium oxide. Coating thickness and density of components within the binder affect the overall transparency. There has been a great deal of work in the glass, roofing, and LED industries to develop these alternative IR reflective coatings but very little has migrated over to the oven doors.

Another possibility is to apply insulating paint and/or reflective paint to a polymer based panel, i.e., the application of insulating or reflective paint is not limited to the metal surfaces only.

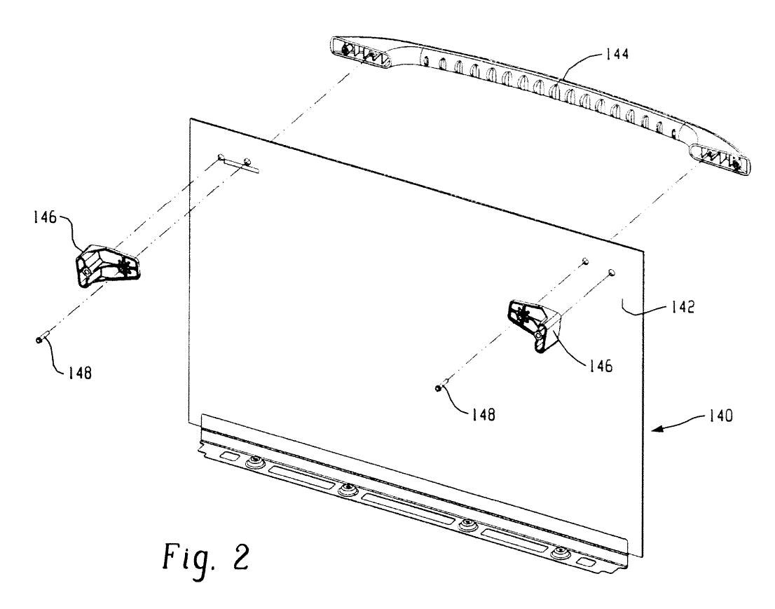

With regard to outer door glass assembly applications, reference is made initially to FIG. 2. Shown there is an outer glass oven door 140 that includes oven glass 140, handle 144, and rear face supports 146 that receive fasteners 148 on an opposite or inner surface of the glass 142 to secure the handle. The inner surfaces of these components receive heat via radiation, convection, and conduction. In order to further reduce the door temperature, the outer surface of the glass oven door could be locally screened, tinted, or painted with an insulating and/or reflective paint to reduce outer surface temperatures.

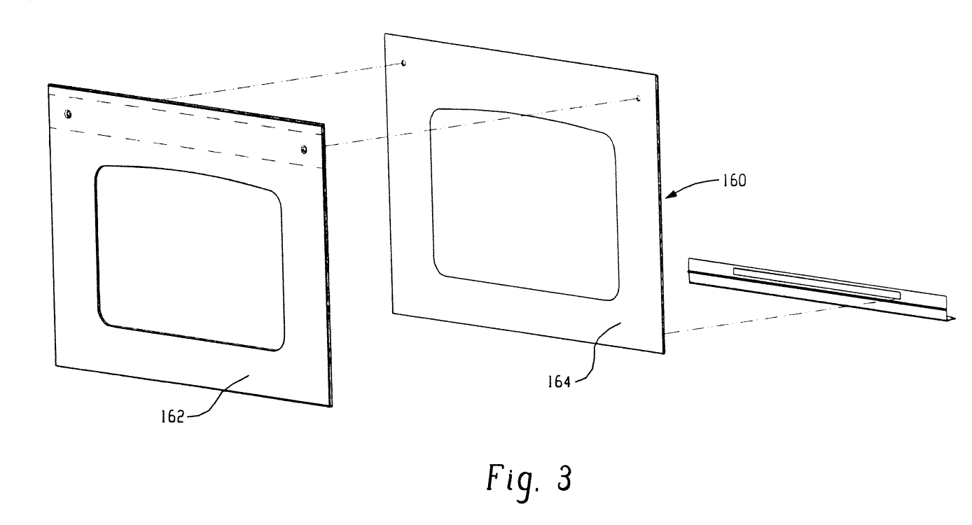

Turning next to FIG. 3, another outer door glass assembly application is illustrated, and particularly a stainless steel model of oven door. In this embodiment, the glass oven door 160 is secured to a stainless steel panel 162 in a conventional manner. Preferably, an outer surface 164 or portions of the outer surface of the oven door glass is locally screened, painted with aluminum paint, tinted, or locally painted with insulating and/or reflective paint to reduce or redirect heat transfer. Further, panel 162 or portions of the panel could be painted with insulation paints, screened or coated, or painted with aluminum paint to locally reduce outer surface temperatures.

Where aluminum paint or coating is used, the aluminum is intended to act as a heat sink and reflective layer. The melting point of aluminum is approximately 1220° F. and therefore aluminum is not conducive for use on a surface that faces the oven chamber since oven temperatures could meet or exceed a melting point if an inadvertent “runaway” oven condition were to occur. Consequently, this use of aluminum paint or coating to act as a heat sink and gradient to direct heat to a low temperature region is an alternative to traditionally applied aluminum-backed tape that is typically secured to a rear side of an outer door glass to reflect radiation or act as a heat sink. In the present arrangement, an aluminum or reflective paint is selectively screened on the non-appearance surface of the door glass for a more effective and controlled reflective or conductive surface. The aluminum screening would act in much the same way as aluminum tape for either reflection or for averaging the temperature over an area, however, the aluminum screening provides much greater design flexibility since a manufacturer can be extremely selective regarding placement of the aluminum screening. The screened aluminum will reduce outer door glass temperatures and thereby either reduce total door cost or reduce the engineering cost to design the door while having the advantage of eliminating labor-intensive application of aluminum tape as used in the prior art.

Reducing radiation through the oven door results in an overall increase in oven efficiency, as well as decreasing the internal door temperatures. This can result in a reduced number of components or parts in the oven doors.

The insulating and/or reflective paint can be effectively applied to whatever surface requires the thermal barrier and selectively screened on the backside of an outer door glass to reduce heat transfer to the outer door glass. The insulating paint could also be painted on the door insulation retainer to provide the desired amount of insulation and thereby either reduce total door cost or reduce engineering cost to design the door. The insulating paint has many of the same advantages as aluminum tape and can be advantageously sprayed onto metal components to eliminate manually intensive assembly steps and/or eliminate components. Other alternatives to aluminized paint would be sol-gel-poly-ceramic matrix coatings that are commercially available under tradenames such as Cerakote™, SPI-SeperTherm™, and Hy-Tech ThermaCels™ ceramic paint additives, or still other such ceramic paint additives that exhibit less than perfect transparency or reflectance may be used. Although coatings like titanium oxide, cadmium stannate, aluminum oxide, etc. may all work on glass, the cost is likely higher and therefore not as desirable.

Applying a reflective thermal barrier coating in lieu of using aluminum tape is proposed so that the inner door and glass surfaces are closer to the temperature of the oven (which would indicate no heat loss and great self-clean performance). Conversely, it is desirable that all other components are at room temperature. It is also contemplated that any one or more of these concepts may be used individually or in combination, or used in combination with conventional materials such as tin oxide.

The disclosure has been described with reference to the preferred embodiments. Obviously modifications and alterations will become apparent to those skilled in the art and these modifications and alterations are deemed to be encompassed herein and as covered by the accompanying claims.

What is claimed is:

1. An assembly for reducing door temperatures in a cooking apparatus:
a cooking appliance having a cooking cavity;
a door assembly secured to the appliance and allowing selective access to the cooking cavity in an open position and limiting access to the cooking cavity in a closed position;
a window forming at least a portion of the door assembly allowing visual inspection of the cooking cavity; and
a door temperature reducing component including at least one of
an insulating and/or reflective paint on components of the door,
a tinting in the window, or
a reflective thermal barrier coating applied to non-visible surfaces of the door assembly.

2. The assembly of claim 1 wherein the door temperature reducing component is used in combination with tin oxide.

3. The assembly of claim 1 wherein the insulating and/or reflective paint reduces heat transfer therethrough or redirects heat transfer.

4. The assembly of claim 1 wherein the insulating and/or reflective paint is applied to at least portions of metal component surfaces facing the oven cavity in a door closed position.

5. The assembly of claim 1 wherein an insulating material incorporated in the paint includes at least one of ceramic fiber, ceramic bead, glass bead, glass fiber, or aerogel.

6. The assembly of claim 1 wherein the insulating and/or reflective paint is applied to at least portions of a retainer, decorative trim, shield, interior or exterior panel.

7. The assembly of claim 1 wherein the window tinting includes a doping material added to a glass that forms the window to reduce heat transfer therethrough.

8. The assembly of claim 1 wherein the window tinting is provided throughout an entirety of the window.

9. The assembly of claim 1 wherein the heat transfer coating is a reflective coating.

10. The assembly of claim 1 wherein the heat transfer coating is a conductive coating.

11. The assembly of claim 1 wherein the heat transfer coating is an aluminum coating on an outer door glass.

12. The assembly of claim 11 wherein the aluminum coating is applied to an interior surface of the outer door glass.

13. The assembly of claim 11 wherein the aluminum coating extends over only a portion of the outer door glass.

14. The assembly of claim 11 wherein the aluminum coating extends over a perimeter portion of the outer door glass.

15. An oven comprising;
a housing including a cooking cavity;
a door that is configured to open and close relative to the housing to provide selective access to the cooking cavity, the door including a window permitting visual inspection of the cooking cavity;
a door temperature reduction feature for limiting radiation of heat from the cooking cavity toward an ambient environment, the door temperature reduction feature including at least one of
a reflective thermal barrier coating applied to non-visible surfaces of the door assembly that directs heat from the cooking cavity away from the outer door glass or decorative trim, or towards a low temperature region,
an insulated paint on at least a portion of a metal component of the door, or
a tint incorporated into the window.

16. The oven of claim 15 wherein the heat transfer coating is an aluminum coating applied to a non-viewing portion of the window.

17. The oven of claim 15 wherein the insulated paint includes an insulating material such as at least one of a ceramic fiber, ceramic bead, glass bead, glass fiber, or aerogel.

18. The oven of claim 15 wherein the tinting is dispersed throughout the window.

19. A method of reducing thermal transfer through a door of a cooking appliance comprising:
providing a housing having a cooking cavity;
providing a door that allows selective access to the cooking cavity; and
reducing heat radiation through the door by at least one of
coating at least a portion of a surface of a window with a reflective thermal barrier coating applied to non-visible surfaces of the door assembly that directs heat from the cooking cavity away from the outer door or decorative trim, or towards a low temperature region,
applying an insulated paint on at least a portion of a metal component of the door, or
incorporating a tint into the window.

20. The method of claim 19 wherein the coating step includes applying aluminum to a surface of the window.

21. The method of claim 19 wherein the coating step includes applying aluminum to a perimeter portion of the window.

22. The method of claim 19 wherein the coating, applying or incorporating steps are used with a tin oxide.
